(19) United States
(12) Patent Application Publication
(10) Pub. No.: US 2003/0091343 A1
(43) Pub. Date: May 15, 2003

(54) Apparatus and method for controlling a rotation speed of a motor

(76) Inventors: Diamond Chen, Taoyuan (TW); Lemon Lin, Taoyuan (TW)

Correspondence Address: BIRCH STEWART KOLASCH & BIRCH, PO BOX 747, FALLS CHURCH, VA, 22040-0747, US

(21) Appl. No.: 10/285,577

(22) Filed: Nov. 1, 2002

(30) Foreign Application Priority Data
Nov. 9, 2001 (TW) 090127858

(51) Int. Cl. H02P 5/00

(52) U.S. Cl. 388/800

(57) ABSTRACT

Disclosed is an apparatus and a method for controlling a rotation speed of a motor. The apparatus includes a detector electrically connected to said motor for generating a first detection signal corresponding to a feedback signal output from said motor; and a controller electrically connected to said motor and said detector for receiving said first detection signal. When said motor rotates at a relatively low rotation speed, said controller generates a first control signal with a first frequency to be output to said motor corresponding to said first detection signal; when said motor rotates at a relatively high rotation speed, said controller generates a second control signal with a second frequency to be output to said motor; wherein said first frequency of said first control signal is greater than said second frequency of said second control signal.

### FIELD OF THE INVENTION

The present invention is related to an apparatus and a method for controlling the rotation speed of a motor, and especially to a controller for controlling the rotation speed of direct-current motor (DC motor) through multi-frequency pulse width modulation (PWM) signals.

### BACKGROUND OF THE INVENTION

Because the direct-current motor (DC motor) has been commonly used in the many equipment, its desired requirement is continously increased and changed rather than only limited to operating at a constant full speed. Thus, the controller of DC motor plays an important role in effectively controlling the rotation speed, torque and operating current and efficiency of the motor so as to optimize the output of the motor.

Generally speaking, the commonly used controller controls the rotation speed of DC motor by a contant frequency, that is, through changing the proportion or percentage of “ON” and “OFF” of the duty cycle. The larger the percentage of “ON” signal, the faster the motor rotates as shown in FIG. 1A. Contrarily, the smaller the percentang of “ON” signal, the slower the motor rotates as shown in FIG. 1B. In other words, this way is called “pulse width modulation (PWM) control”. However, because the frequency of the PWM sugnal is constant, it will generate a lot of noise and vibration from the magnetic switch when the motor rotates at a relatively low speed if the used frequency is very low, as shown in FIG. 2A. Although the acoustic frequency of human being ranges from 20 Hz to 20 KHz, people can hear the noise generated when the frequency is lower than 10 KHz. If the frequency of the PWM signal is constant at a relatively higher frequency as shown in FIG. 2B, the efficiency of the DC motor will become worse. Furthermore, it is well known that the motor has a winding coil for generating an inductance (L) and the inductive impedance is 2πfL. Thus, the higher the frequency of the PWM signal, the greater the inductive impedance and the smaller the output torque. Moreover, the electronic elements of the controller will easily generate a lot of heat, thereby consuming much energy.

Therefore, it is desirable to develop a method and an apparatus for effectively controlling the rotation speed of the DC motor.

### SUMMARY OF THE INVENTION

An object of the present invention is to provide an apparatus and a method for controlling the motor, which can control the rotation speed of the motor through two or more stages of different frequencies of pulse width modulation (PWM) signals whose percentage of “ON” signal of the duty cycle can range from 0% to 100%.

Another object of the present invention is to provide a controlling apparatus and method of a direct-current motor (DC motor), which can control the rotation speed of motor through multi-frequency pulse width modulation (PWM) signals so as to effectively reduce the noise and increase the efficiency of motor, instead of a conventional controller utilizing the contant-frequency PWM signal.

According to the present invention, the apparatus for controlling a rotation speed of a motor includes a detector electrically connected to the motor for generating a first detection signal corresponding to a feedback signal output from the motor, and a controller electrically connected to the motor and the detector for receiving the first detection signal. When the motor rotates at a relatively low rotation speed, the controller generates a first control signal with a first frequency to be output to the motor corresponding to the first detection signal; when the motor rotates at a relatively high rotation speed, the controller generates a second control signal with a second frequency to be output to the motor; wherein the first frequency of the first control signal is greater than the second frequency of the second control signal.

Preferably, the motor is a direct-current motor (DC motor). In addition, the detector can be a current detector for detecting a current flowing through the motor, or a rotation speed detector for detecting an actual rotation speed of the motor, so as to generate the detection signal,

Preferably, the controller is a pulse width modulation (PWM) control circuit which includes a plurality of AND gates to control outputs of the first control signal and the second control signals, respectively. Thus, the first control signal and the second control signals are pulse width modulation (PWM) signals, respectively.

Preferably, the first frequency of the first control signal is greater than 10 kHz.

The present invention may best be understood through the following description with reference to the accompanying drawings, in which:

### BRIEF DESCRIPTION OF THE DRAWINGS

FIG. 1A shows the wave form of the pulse width modulation (PWM) signal output from the conventional PWM control circuit when the direct-current (DC) motor rotates at a relatively low rotation speed;

FIG. 1B shows the wave form of the pulse width modulation (PWM) signal output from the conventional PWM control circuit when the direct-current (DC) motor rotates at a relatively high rotation speed;

FIGS. 2A and 2B respectively show the wave forms of the high-frequency and low-frequency PWM signals output from the conventional PWM control circuit;

FIG. 3 shows the situation of controlling the rotation speed of the motor by multiple-frequency PWM signals according to the present invention;

FIG. 4 is a block diagram showing the method for controlling the rotation speed of the motor in accordance with the present invention;

FIG. 5 is a circuit diagram showing a preferred embodiment of the controlling apparatus of the motor according to the present invention; and

FIGS. 6A and 6B respectively show the detailed circuits providing the PWM 1 and PWM 2 signals shown in FIG. 5.

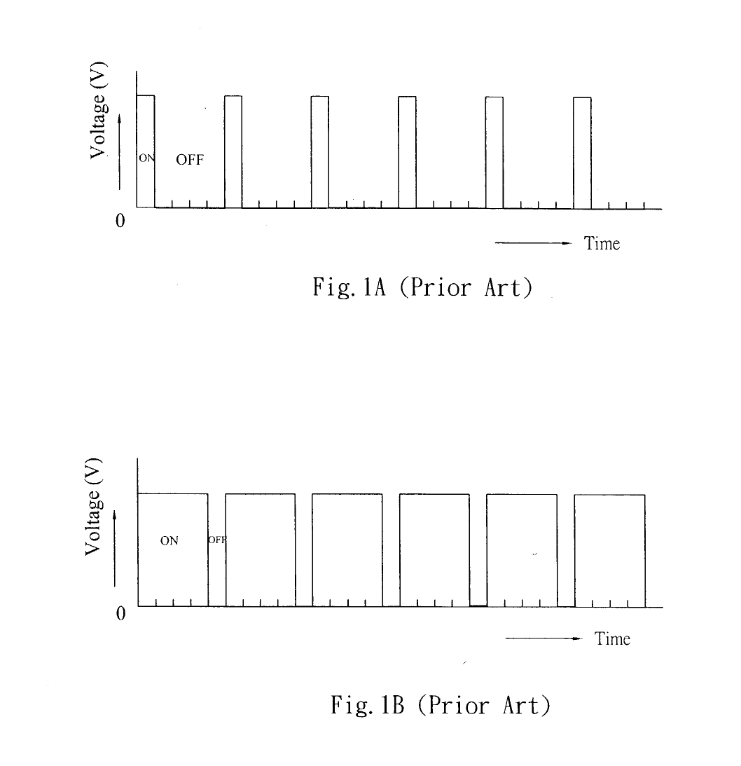

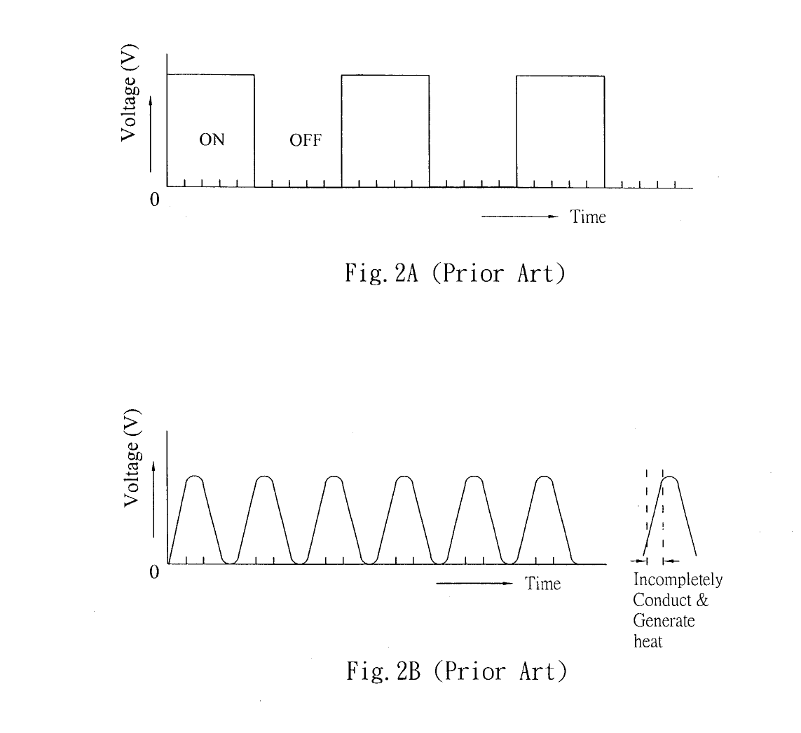

### DETAILED DESCRIPTION OF THE PREFERRED EMBODIMENT

The present invention will now be described more detailedly with reference to the following embodiments. It is to be noted that the following descriptions of the preferred embodiments of this invention are presented herein for the purpose of illustration and description only. It is not intended to be exhaustive or to be limited to the precise form disclosed.

In a preferred embodiment of the present invention, the apparatus for controlling a rotation speed of a motor (e.g. a direct-current motor (DC motor)) includes a current detector electrically connected to the motor for generating a first detection signal corresponding to the current flowing through the motor; and a controller electrically connected to the motor and the current detector for receiving the first detection signal.

When the motor rotates at a relatively low rotation speed, the controller generates a first control signal with a first frequency to be output to the motor corresponding to the first detection signal; when the motor rotates at a relatively high rotation speed, the controller generates a second control signal with a second frequency to be output to the motor; wherein the first frequency of the first control signal is greater than the second frequency of the second control signal.

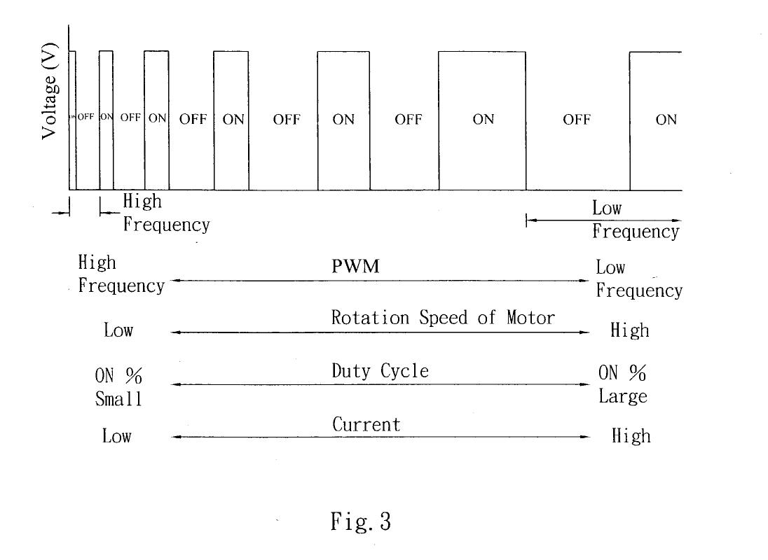

Please refer to FIG. 3 which shows the controlling principle of the present invention. When the motor operates at a relatively high rotation speed, not only the current but also the “ON” percentage of the duty cycle will be increased and the frequency of the pulse width modulation (PWM) signal is also decreased such that the motor can effectively output the greater torque to prevent the electronic device from generating a lot of heat under so large current. On the contrary, when the motor operates at a relatively low rotation speed, in addition that the current and the “ON” percentage of the duty cycle will be decreased, the frequency of pulse width modulation (PWM) signal is also increased to more than 10 kHz to prevent people from hearing the noise.

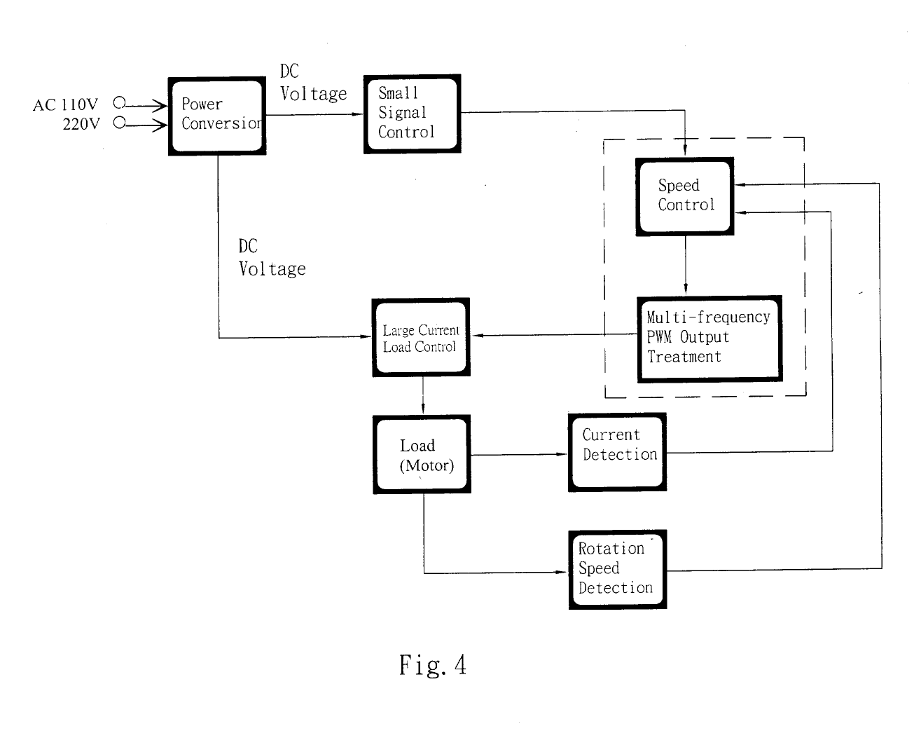

Now, please refer to FIG. 4 which is a block diagram showing the preferred embodiment of the method for controlling a rotation speed of a motor in accordance with the present invention. First of all, if the supplied utility is alternating-current (AC) voltage 220V and 110V, they must be converted to direct-current (DC) voltages 180V and 90V for the big-current load control and the small signal control, respectively. The so-called big-current load means the load of the motor and the small signal control indicates the control of pulse width modulation (PWM) signal. Alternatively, two direct-current (DC) voltage 24V and 12V can be directly provided without needing the power conversion, wherein the former is supplied for driving the motor to rotate and the latter is used for providing the basic voltage of the controller. After detecting the current flowing through the motor, the first detection signal is provided for the PWM signal control circuit 53 to control and output the PWM signal with different frequencies so as to control the rotation speed of the motor.

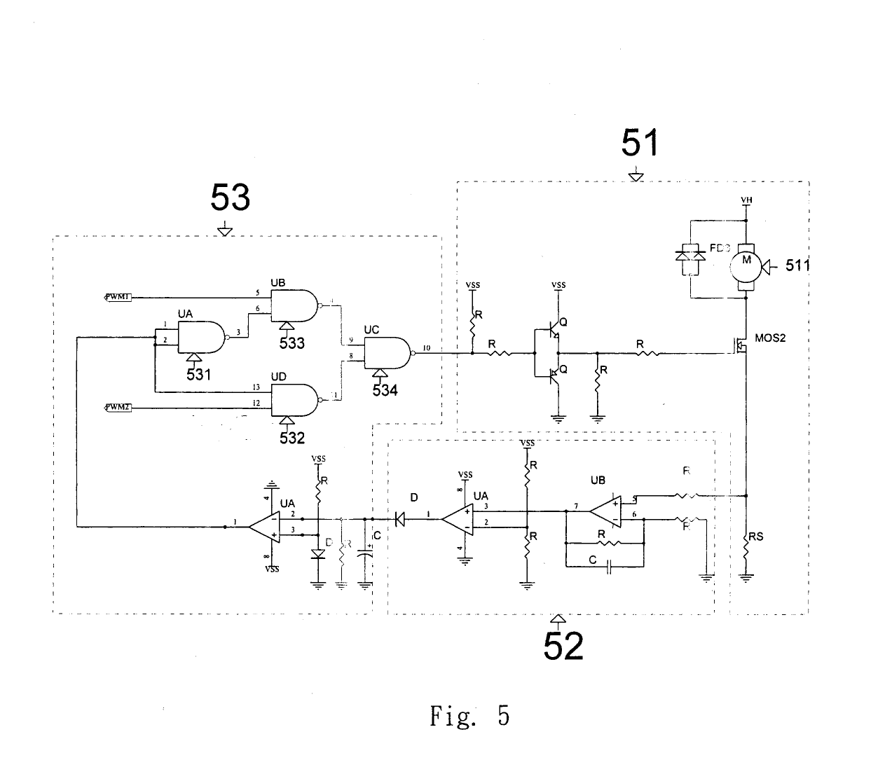

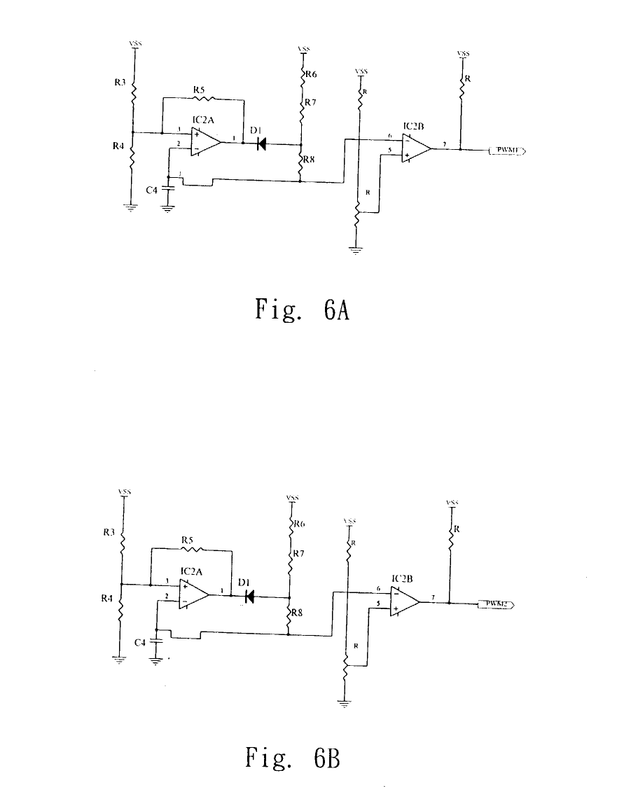

In addition, please refer to FIG. 5 which is a circuit diagram showing the preferred embodiment of the apparatus for controlling a rotation speed of a motor in the present invention. According to the aspect of the present invention, the controller can be a pulse width modulation (PWM) control circuit 53. The pulse width modulation (PWM) control circuit 53 further includes a plurality of AND gates 531, 532, 533, 534 to control outputs of the first control signal and the second control signals, respectively. The first control signal and the second control signals are pulse width modulation (PWM) signals, respectively. The current detector 52 is utilized to detect the current flowing through the motor 511 in the big-current load region 51 and provides a detection signal to the PWM signal control circuit 53. The plurality of AND gates 531, 532, 533, 534 in the PWM signal control circuit 53 can be used to decide the output of PWM signals of different frequencies. Thus, except changing the current and the “ON” percentage of the duty cycle, the frequency of the PWM signals can also be changed. For the sake of convenience, two PWM signals of different frequencies PWM1, PWM2 are exemplified and FIGS. 6A and 6B are the detailed circuit diagrams showing how to provide the PWM1 and PWM2 signals. When the motor is operated in an abnormal condition, the detection signal input into the PWM signal control circuit 53 becomes high level and the PWM2 signal will be generated. On the contrary, when the motor is operated in a normal condition, the detection signal input into the PWM signal control circuit 53 becomes low level and the PWM1 signal will be generated.

Certainly, the aspect of the present invention is not limited to the two-stage frequency control, but it can also be applied to multi-stage frequency control. In addition to utilize the detection of current flowing through the motor so as to generate a feedback detection signal, the detection signal can also be generated corresponding to the detection of actual rotation speed. Alternatively, the current and the actual rotation speed can be detected at the same time. On the other hand, in addition to the function of pulse width modulation, the frequency can be changed along with the different used conditions such that the output of the DC motor can attain the best conditions of high torque, high efficiency and low noise.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An apparatus for controlling a rotation speed of a motor comprising:
a detector electrically connected to said motor for generating a first detection signal corresponding to a feedback signal output from said motor; and
a controller electrically connected to said motor and said detector for receiving said first detection signal;
when said motor rotates at a relatively low rotation speed, said controller generates a first control signal with a first frequency to be output to said motor corresponding to said first detection signal; when
said motor rotates at a relatively high rotation speed, said controller generates a second control signal with a second frequency to be output to said motor; wherein said first frequency of said first control signal is greater than said second frequency of said second control signal.

2. The apparatus according to claim 1 wherein said motor is a direct-current motor (DC motor).

3. The apparatus according to claim 1 wherein said detector is a current detector for detecting a current flowing through said motor so as to generate said first detection signal.

4. The apparatus according to claim 3 further comprising a rotation speed detector electrically connected to said motor and said controller for generating a second detection signal to be output to said controller corresponding to an actual rotation speed of said motor.

5. The apparatus according to claim 1 wherein said detector is a rotation speed detector for detecting an actual rotation speed of said motor so as to generate said first detection signal to be output to said controller.

6. The apparatus according to claim 1 wherein said controller is a pulse width modulation (PWM) control circuit.

7. The apparatus according to claim 6 wherein said pulse width modulation (PWM) control circuit includes a plurality of AND gates to control outputs of said first control signal and said second control signals, respectively.

8. The apparatus according to claim 7 wherein said first control signal and said second control signals are pulse width modulation (PWM) signals, respectively.

9. The apparatus according to claim 1 wherein said first frequency of said first control signal is greater than 10 kHz.

10. A method for controlling a rotation speed of a motor comprising the steps of:
generating a first detection signal corresponding to a feedback signal output from said motor; and
receiving said first detection signal through a controller electrically connected to said motor, when said motor rotates at a relatively low rotation speed, said controller generates a first control signal with a first frequency to be output to said motor corresponding to said first detection signal; when said motor rotates at a relatively high rotation speed, said controller generates a second control signal with a second frequency to be output to said motor; wherein said first frequency of said first control signal is greater than said second frequency of said second control signal.

11. The method according to claim 10 wherein said motor is a direct-current motor (DC motor).

12. The method according to claim 10 further comprising a step of generating a second detection signal to be output to said controller corresponding to an actual rotation speed of said motor.

13. The method according to claim 10 wherein said controller is a pulse width modulation (PWM) control circuit.

14. The method according to claim 13 wherein said pulse width modulation (PWM) control circuit includes a plurality of AND gates to control outputs of said first control signal and said second control signals, respectively.

15. The method according to claim 13 wherein said first control signal and said second control signals are pulse width modulation (PWM) signals, respectively.

16. The method according to claim 10 wherein said first frequency of said first control signal is greater than 10 kHz.

17. A multi-frequency motor controller for controlling a rotation speed of a motor comprising:
a detector electrically connected to said motor for generating a first detection signal corresponding to a feedback signal output from said motor; and
a controlling device electrically connected to said motor and said detector for receiving said first detection signal;
when said motor rotates at a relatively low rotation speed, said controlling device generates a first control signal with a first frequency to be output to said motor corresponding to said first detection signal; when said motor rotates at a relatively high rotation speed, said controlling device generates a second control signal with a second frequency to be output to said motor; wherein said first frequency of said first control signal is greater than said second frequency of said second control signal.

18. The apparatus according to claim 17 wherein said detector is a current detector or a rotation speed detector.
